(19) United States
(12) Patent Application Publication
(10) Pub. No.: US 2022/0319176 A1
(43) Pub. Date: Oct. 6, 2022

(54) METHOD AND DEVICE FOR RECOGNIZING OBJECT IN IMAGE BY MEANS OF MACHINE LEARNING

(71) Applicant: ZACKDANG COMPANY, Nambusunhwan-ro, Gangnam-gu (KR)

(72) Inventor: Jae Hyun KIM, Goyang-si (KR)

(73) Assignee: ZACKDANG COMPANY, Seoul (KR)

(21) Appl. No.: 17/763,977

(22) PCT Filed: Jul. 17, 2020
(86) PCT No.: PCT/KR2020/009479

§ 371 Date: Mar. 25, 2022

(30) Foreign Application Priority Data
Sep. 29, 2019 (KR) 10-2019-0120261
Feb. 7, 2020 (KR) 10-2020-0015042

(51) Int. Cl. G06V 20/40; G06V 10/26; G06V 10/70; G06N 20/00

(52) U.S. Cl. CPC G06V 20/49; G06V 10/26; G06V 10/70; G06N 20/00

(57) ABSTRACT

The present invention relates to a method and device for recognizing an object in an image by means of machine learning. A method for recognizing an object according to an embodiment of the present invention can comprise the steps of: (a) obtaining an object-related image; and (b) recognizing an object and object display time from the obtained object-related image by means of an object recognition deep learning model.

### TECHNICAL FIELD

The present invention relates to a method and device for recognizing an object in an image through machine learning, and more particularly, to a method and device for recognition of an object and an object display time by means of machine learning.

### BACKGROUND ART

Recently, sharing personal know-how is moving from TEXT message to video image. If an object used in the video image can be identified, various business models may be applied and may become the basis for extensively processing contents. Artificial substitution by people to implement such work as described above takes a lot of time and capital labor, and entails difficulties in maintaining desired quality control. Utilizing the above application will be meaningful as useful information for both the people who process the image and those who are provided with know-how through the image.

However, in the process of recognizing an object in an image, there is a problem that initial data collection effort to collect and tag a large quantity of image learning data is too great.

### DISCLOSURE

### Technical Problem

The present invention was created to solve the above-described problem, and an object of the present invention is to provide a method and device for recognizing objects in images through machine learning.

Further, the present invention is intended to improve conventional situation in which learning can be implemented only when human manual work is massively invested to find an object in an image by introducing artificial intelligence.

Further, the present invention provides a device and method capable of recognizing an object in an image on the basis of the nature of the object in a short time by introduction of a spiral learning model that originally starts with a small quantity of about several hundreds and can begin product learning.

The objects of the present invention are not limited to those mentioned above, but other objects not mentioned herein will also be clearly understood from the following description.

### Technical Solution

In order to achieve the above objects, the object recognition method according to an embodiment of the present invention may include steps of: (a) acquiring an object-related image; and (b) recognizing the object and an object display time from the acquired object-related image by means of an object recognition deep learning model.

In an embodiment, the step (a) may include: acquiring the object-related image; dividing the object-related image into a plurality of frames; and determining a frame including the object among the above plurality of frames.

In an embodiment, the step (b) may include: training the object recognition deep learning model with a learning image of pre-tagged object; and tagging an object included in the object-related image using the trained object recognition deep learning model.

In an embodiment, the learning\ may include determining a feature from a learning image of the pre-tagged object; and converting the determined feature into a vector value.

In an embodiment, the object recognition method may further include displaying the object-related image on the basis of the object and the object display time.

In an embodiment, the object recognition method may include; acquiring an input for the object display time; and displaying a frame including the object corresponding to the object display time among the plurality of frames.

In an embodiment, an object recognition device may include: a communication unit that acquires an image related to an object; and a control unit for recognizing the object and an object display time from the acquired object-related image by means of an object recognition deep learning model.

In an embodiment, the communication unit may acquire the object-related image, while the control unit may divide the object-related image into a plurality of frames and determine a frame including the object among the plurality of frames.

In an embodiment, the control unit may train the object recognition deep learning model with a learning image of the pre-tagged object, and then tag an object included in the object-related image using the trained object recognition deep learning model.

In an embodiment, the control unit may determine a feature from the learning image of the pre-tagged object and convert the determined feature into a vector value.

In an embodiment, the object recognition device may further include a display unit that displays the object-related image on the basis of the object and the object display time.

In an embodiment, the object recognition device may include: an input unit for acquiring an input for the object display time; and a display unit for displaying a frame including the object corresponding to the object display time among the plurality of frames.

Detailed matters for achieving the above objects will become apparent with reference to the embodiments to be described later in detail together with the accompanying drawings.

However, the present invention is not limited to the embodiment disclosed below but may be configured in various different forms, and such embodiments may be provided to complete the disclosure of the present invention and completely inform the scope of the invention to those of ordinary skill in the technical field to which the present invention pertains (hereinafter, referred to as “those skilled in the art”).

### Advantageous Effects

According to an embodiment of the present invention, an object in an image may be detected and used through machine learning so that more abundant and useful service can be provided with respect to the provision of image contents.

Further, according to an embodiment of the present invention, it is possible to know a situation in which diverse products in video images are being used, and to specify how much a specific brand or product is required in the image.

Further, according to an embodiment of the present invention, it is possible to respond customer's curiosity and provide a service in order to directly enter a place where a specific product in a long time image is exposed.

Effects of the present invention are not limited to the above-described effects, and potential effects expected by the technical features of the present invention will be clearly understood from the following description.

### DESCRIPTION OF DRAWINGS

FIG. 1 is a diagram illustrating an object recognition method according to an embodiment of the present invention.

FIG. 2a is a diagram illustrating an example of image collection according to an embodiment of the present invention.

FIG. 2b is a diagram illustrating an example of training an object recognition deep learning model according to an embodiment of the present invention.

FIGS. 2c and 2d are diagrams illustrating an example of object recognition according to an embodiment of the present invention.

FIG. 3 is a diagram illustrating a preliminary preparation operating method for object recognition according to an embodiment of the present invention.

FIG. 4 is a diagram illustrating a recognition extracting operation method for object recognition according to an embodiment of the present invention.

FIG. 5 is a diagram illustrating a functional configuration of the object recognition device according to an embodiment of the present invention.

### BEST MODE

In the present invention, various modifications may be made and various embodiments may be provided, and specific embodiments will be illustrated in the drawings and described in detail below.

Various features of the invention disclosed in the claims may be better understood in view of the drawings and detailed description. The device, method, preparation method and various embodiments disclosed in the specification are provided for illustration purposes. The disclosed structural and functional features are intended to enable those skilled in the art to specifically implement various embodiments, but not to limit the scope of the invention. The disclosed terms and sentences are intended to describe various features of the disclosed invention to easily understand the same but not to limit the scope of the invention.

In describing the present invention, when it is considered that a detailed description of related and known technology may unnecessarily obscure the subject matter of the present invention, a detailed description thereof will be omitted.

Hereinafter, a method and device for recognizing an object in an image through machine learning according to an embodiment of the present invention will be described.

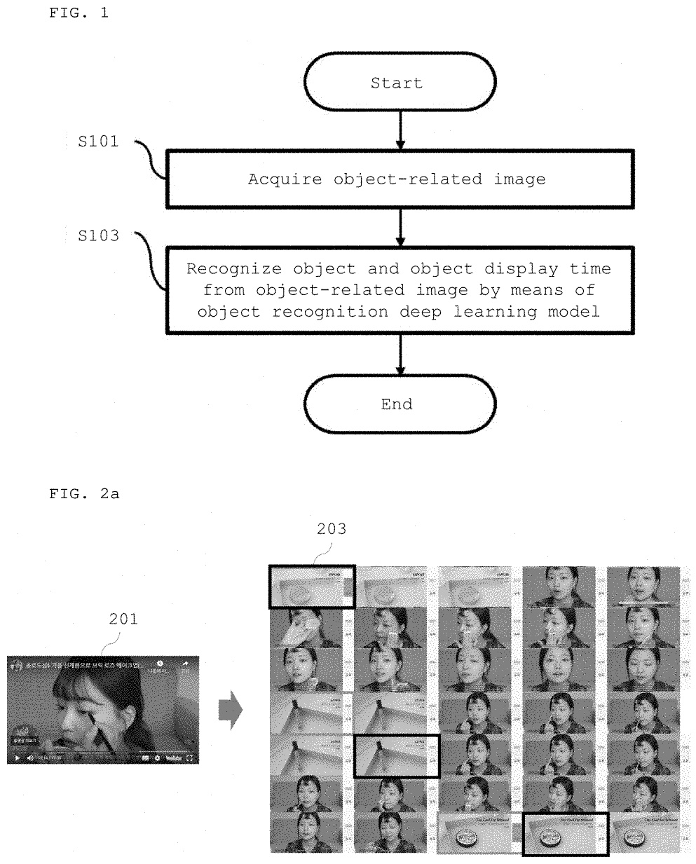

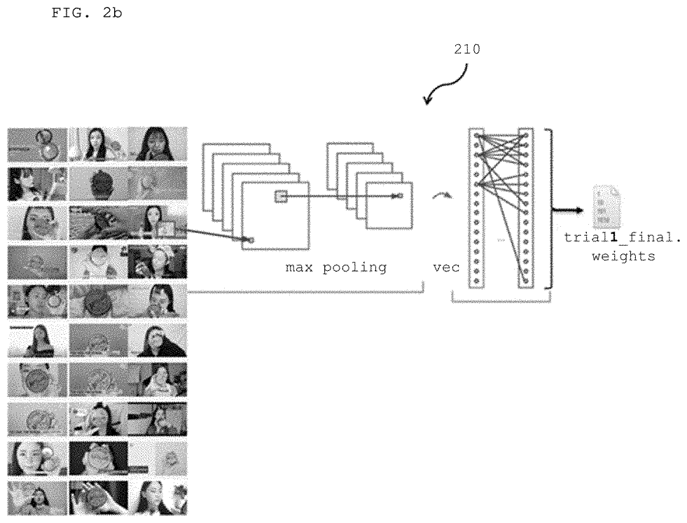

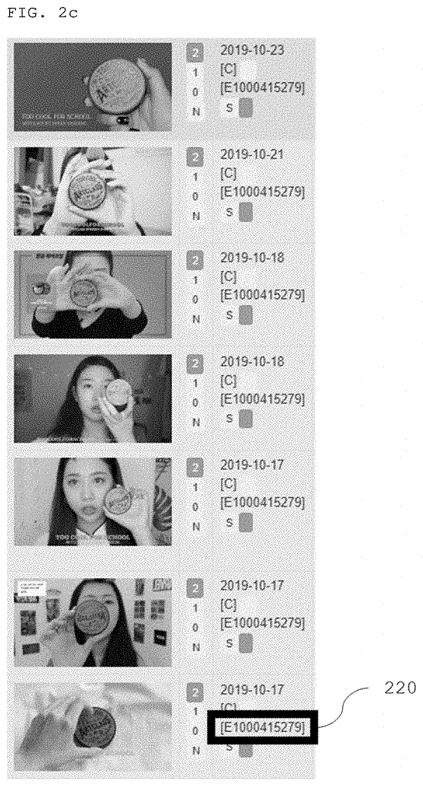

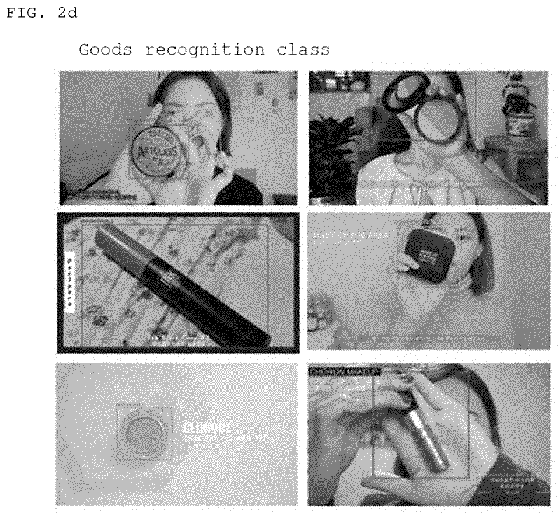

FIG. 1 is is diagram illustrating an object recognition method according to an embodiment of the present invention, FIG. 2a a diagram illustrating an example of image collection according to an embodiment of the present invention. FIG. 2b is a diagram illustrating an example of training an object recognition deep learning model according to an embodiment of the present invention. FIGS. 2c and 2d are diagrams illustrating an example of object recognition according to an embodiment of the present invention.

Referring to FIG. 1, step S101 may include acquiring an image related to an object (“object-related image”). In one embodiment, referring to FIG. 2a, an object-related image 201 may be acquired and divided into a plurality of frames, and a frame 203 including an object among the plurality of frames may be determined.

For example, the plurality of frames may be generated by dividing the object-related image 201 in unit of 1 second.

Step S103 may include recognizing the object and an object display time from the object-related image by means of an object recognition deep learning model.

In one embodiment, referring to FIG. 2b, the object recognition deep learning model 210 may be trained with a learning image of pre-tagged object. For example, a feature may be determined from the learning image of pre-tagged object, and the determined feature may be converted into a vector value.

In one embodiment, referring to FIGS. 2c and 2d, an object ID 220 and an object display time for a screen on which the object is displayed may be determined.

In one embodiment, the object-related image may be displayed on the basis of the object and the object display time.

In one embodiment, an input for the object display time may be acquired, and a frame including the object corresponding to the object display time among the plurality of frames may be displayed.

In one embodiment, when the number of inputs for the object display time by a user is greater than or equal to a threshold value, a list of at least one object-related image including the object corresponding to the object display time may be displayed.

In other words, if the number of time warps to the corresponding object display time is more than a certain value, the user's preference for the object is determined to be high and a list of different images related to the object may be provided to the user, thereby improving utility of object search by the user.

For example, the object may include a variety of products such as cosmetics, accessories, fashion goods, etc., but is not particularly limited thereto.

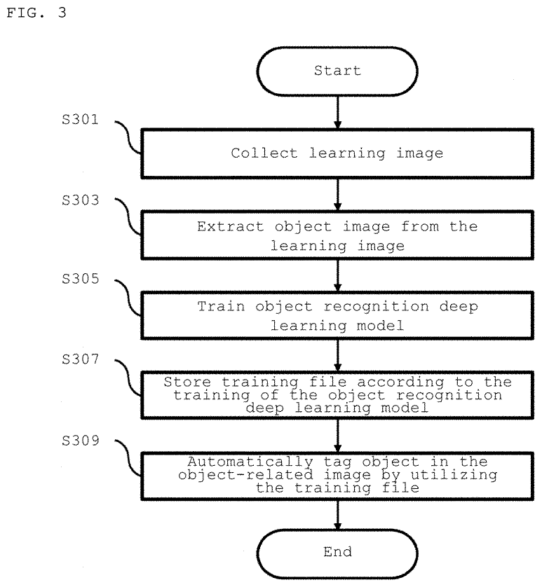

FIG. 3 is a diagram illustrating a preliminary preparation operating method for object recognition according to an embodiment of the present invention.

Referring to FIG. 3, step S301 may include collecting a learning image through its own algorithm. Herein, the learning image may include an image for training an object recognition deep learning model.

In one embodiment, a keyword existing in the learning image may be identified, and useable images and disable images may be distinguished by the keywords through its own algorithm.

Step S303 may include extracting an object image from the learning image. For example, in order to minimize blur and spreading phenomena, the learning image may be subdivided by extracting the object image every second.

Step S305 may include training the object recognition deep learning model 210 using the object image. In this case, the object image may include a learning image of the object.

At this time, the object of the learning image may be tagged in advance by the user. That is, it is possible to acquire and introduce the minimum quantity able to be minimized by tagging an object with intervention of the first user.

Thereafter, a feature of the object image may be identified to calculate a vector form. For example, the object recognition deep learning model 210 may include a YOLO algorithm, a single shot multibox detector (SSD) algorithm, a CNN algorithm, etc., but does not exclude application of other algorithms.

Step S307 may include storing a training file calculated according to the training of the object recognition deep learning model 210. In this case, the training file may move to a server for extraction and determine appropriation of the extraction.

Step S309 may include automatically tagging an object in the object-related image using the training file. In other words, this is an automatic tagging step in which an object in a newly introduced object-related image can be automatically introduced into learnable data.

In one embodiment, since a recognition rate increases by acquiring high-quality learning images more and more and training with the same, steps S305 to S309 may be repeatedly implemented until a desired recognition rate is achieved by repeatedly training with the same.

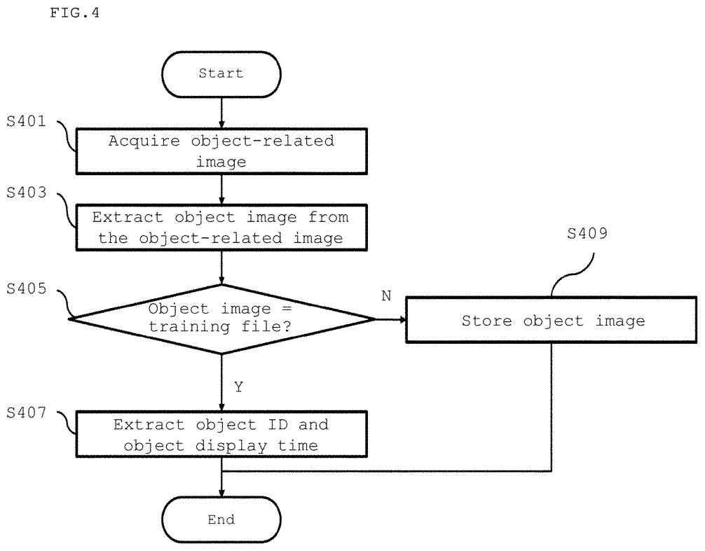

FIG. 4 is a diagram illustrating a recognition extracting operation method for object recognition according to an embodiment of the present invention.

Referring to FIG. 4, step S401 may include acquiring an object-related image. That is, a new image may be input. In one embodiment, a new image may be acquired in the same manner as in the step S301 of FIG. 3.

In step S403, an object image may be extracted from the object-related image. In other words, a frame including the object may be extracted from the object-related image. For example, an image may be extracted in unit of 1 second in order to input the image of an object.

Step S405 may include determining whether the object image matches with the training file generated by the object recognition deep learning model. In other words, it is possible to find the type of the object using the object image and the training file. Herein, the training file may include an existing object DB (database).

Step S407 may include extracting ID (identification) of an object corresponding to the object image and an object display time when the object image matches with the training file generated by the object recognition deep learning model.

Step S409 may include storing the object image in order to register a new image when the object image does not match with the training file generated by the object recognition deep learning model.

In other words, non-matching data may be manually tagged and used for training the object recognition deep learning model in order to configure a system to smoothly create a virtuous cycle so that the data can be matched with the object DB in the next recognition extraction step.

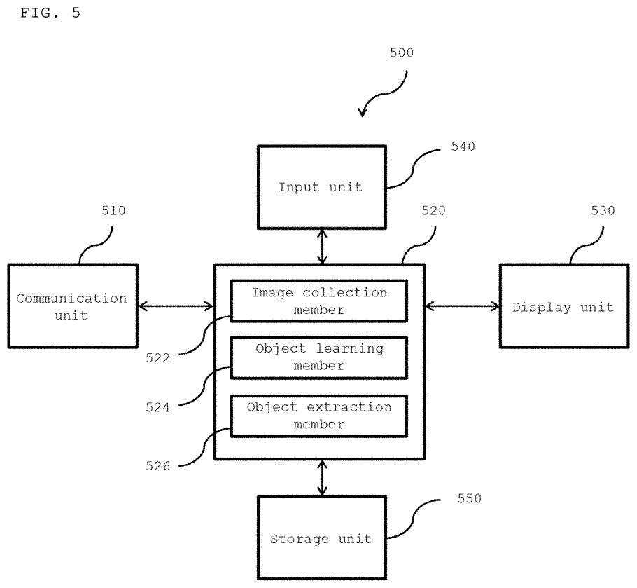

FIG. 5 is a diagram illustrating a functional configuration of the object recognition device according to an embodiment of the present invention.

Referring to FIG. 5, an object recognition device 50 may include a communication unit 510, a control unit 520, a display unit 530, an input unit 540 and a storage unit 550.

The communication unit 510 may acquire an object-related image.

In one embodiment, the communication unit 510 may include at least one of a wired communication module and a wireless communication module. The entire or a part of the communication unit 510 may be referred to as a “transmitter”, “receiver” or “transceiver”.

The control unit 520 may recognize an object and an object display time from an object-related image through an object recognition deep learning model.

In one embodiment, the control unit 520 may include an image collection member 522 to collect beauty-related creators and related images; an object learning member 524 that gathers the collected images, implements deep learning, and automatically tags and learns new products by utilizing the previously learned learning data; and an object extraction member 526 to distinguish what this product is from among the products learned when a specific image is suggested.

In one embodiment, the control unit 520 may include at least one processor or micro-processor, or a part of the processor. Further, the control unit 520 may also be referred to as a “communication processor (CP)”. The control unit 520 may control operation of the object recognition device 500 according to a variety of embodiments of the present invention.

The display unit 530 may display an object-related image on the basis of the object and the object display time. In one embodiment, the display unit 530 may display a frame including the object corresponding to the object display time among a plurality of frames.

In one embodiment, the display unit 530 may display information processed by the object recognition device 500. For example, the display unit 530 may include at least any one among a liquid crystal display (LCD), a light emitting diode (LED) display, an organic light emitting diode (OLED) display, a micro-electromechanical system (MEMS) display and an electronic paper display.

The input unit 540 may acquire an input for the object display time. In one embodiment, the input unit 540 may acquire an input for an object display time by a user.

The storage unit 550 may store a training file for the object recognition deep learning model 210, an object-related image, an object ID and an object display time.

In one embodiment, the storage unit 550 may be configured of a volatile memory, a nonvolatile memory or a combination of the volatile memory and the nonvolatile memory. Further, the storage unit 550 may provide stored data according to the request of the control unit 520.

Referring to FIG. 5, the object recognition device 500 may include a communication unit 510, a control unit 520, a display unit 530, an input unit 540 and a storage unit 550. In various embodiments of the present invention, the object recognition device 500 may be implemented as having more or fewer configurations than the configurations illustrated in FIG. 5 since the configurations illustrated in FIG. 5 are not essential.

According to the present invention, a system is constructed such that original hundreds of images are manually learned and then other images may be automatically extracted using the learned data.

Further, according to the present invention, the system may be constructed such that, after inputting object images, some of the images able to be automatically tagged can be automatically tagged while the others not being automatically tagged are separately collected and then tagged, thereby desirably minimizing human manual work.

Further, according to the present invention, in order to minimize collection of the original data, learning may be performed using a small quantity of the original data, followed by utilizing the learned data to automatically extract a shape of image and using the same in creating learning data. The above process may be repeated to learn high-quality learning data.

The above description is merely illustrative of the technical idea of the present invention, and those skilled in the art will be able to make various alterations and modifications without departing from the essential characteristics of the present invention.

Accordingly, the embodiments disclosed in the present specification are not intended to limit the technical idea of the present invention, but are intended to describe the present invention, therefore, the scope of the present invention is not limited by these embodiments.

The scope of protection of the present invention should be interpreted by the appended claims, and all technical ideas within the scope equivalent thereto should be understood as being included in the scope of the present invention.

1. An object recognition method, comprising:
(a) acquiring an image related to an object (“object-related image”); and
(b) recognizing the object and an object display time from the acquired object-related image by means of an object recognition deep learning model.

2. The object recognition method according to claim 1, wherein the step (a) includes:
acquiring the object-related image;
dividing the object-related image into a plurality of frames; and
determining a frame including the object among the plurality of frames.

3. The object recognition method according to claim 1, wherein the step (b) includes:
training the object recognition deep learning model with a learning image of pre-tagged object; and
tagging the object included in the object-related image using the trained object recognition deep learning model.

4. The object recognition method according to claim 3, wherein the training includes:
determining a feature from the learning image of the pre-tagged object; and
converting the determined feature into a vector value.

5. The object recognition method according to claim 1, further comprising:
displaying the object-related image on a basis of the object and the object display time.

6. The object recognition method according to claim 2, further comprising:
acquiring an input for the object display time; and
displaying a frame including the object corresponding to the object display time among the plurality of frames.

7. An object recognition device, comprising:
a communication unit to acquire an object-related image; and
a control unit that recognizes the object and an object display time from the acquired object-related image by means of an object recognition deep learning model.

8. The object recognition device according to claim 7, wherein the communication unit acquires the object-related image; and
the control unit divides the object-related image into a plurality of frames, and determines a frame including the object among the plurality of frames.

9. The object recognition device according to claim 7, wherein the control unit trains the object recognition deep learning model with a learning image of pre-tagged object, and tags the object included in the object-related image using the trained object recognition deep learning model.

10. The object recognition device according to claim 9, wherein the control unit determines a feature from the learning image of the pre-tagged object, and converts the determined feature into a vector value.

11. The object recognition device according to claim 7, further comprising:
a display unit to display the object-related image on the basis of the object and the object display time.

12. The object recognition device according to claim 8, further comprising:
an input unit that acquires an input for the object display time; and
a display unit that displays a frame including the object corresponding to the object display time among the plurality of frames.
